(19) United States
(12) Patent Application Publication
(10) Pub. No.: US 2025/0159761 A1
(43) Pub. Date: May 15, 2025

(54) HEATER

(71) Applicants: Hyundai Motor Company, Seoul (KR); Kia Corporation, Seoul (KR)

(72) Inventor: Gun Goo Lee, Suwon-si (KR)

(21) Appl. No.: 18/643,128

(22) Filed: Apr. 23, 2024

(30) Foreign Application Priority Data
Nov. 13, 2023 (KR) 10-2023-0156609

(51) Int. Cl. H05B 1/02; H01M 10/615; H01M 10/657

(52) U.S. Cl. CPC H05B 1/0205; H01M 10/615; H01M 10/657; H01M 2200/103

(57) ABSTRACT

An embodiment heater includes a housing member having an internal space for storing a cooling fluid, a heating member accommodated in the internal space to generate heat, a partition wall member disposed at a first side of the heating member, extending in an upward/downward direction, and sealing the internal space, a fuse member disposed at a side of the partition wall member opposite a side facing the internal space and configured to cut off a supply of electric power to the heating member in a case in which a temperature of the fuse member exceeds a predetermined temperature, and a heat transfer member having a first side disposed to be in contact with the partition wall member and a second side disposed to be in contact with the fuse member, the heat transfer member being configured to transfer thermal energy to the fuse member from the partition wall member.

### CROSS-REFERENCE TO RELATED APPLICATIONS

This application claims the benefit of Korean Patent Application No. 10-2023-0156609, filed on Nov. 13, 2023, which application is hereby incorporated herein by reference.

### TECHNICAL FIELD

The present disclosure relates to a heater.

### BACKGROUND

The temperature of a battery needs to be within a predetermined temperature range so that the battery operates normally. To this end, many pieces of equipment with batteries are also equipped with heaters to raise the temperatures of the batteries. In particular, in the case of a vehicle equipped with a battery, the battery is in a low-temperature state when the temperature of the vehicle is low because of a low temperature of outside air, which makes it difficult for the battery to operate smoothly. The heater for raising a temperature is an essential component of an electric vehicle in which a high-capacity battery is mounted.

Typically, the heater for raising a temperature includes a heat generating member disposed in a housing and configured to generate heat by receiving electric power, a partition wall member configured to seal an internal space of the housing from the outside, and a fuse member configured to cut off the supply of electric power to the heat generating member when the temperature exceeds a predetermined temperature.

Meanwhile, in the case of the heater for raising a temperature in the related art, metal such as aluminum is often used for a material of the housing that constitutes a body of the heater. However, metal is expensive and heavy in weight, which makes it difficult for operators to mount the heater for raising a temperature in the equipment such as the vehicle. Therefore, a plastic material, which is light in weight and inexpensive, is considered to be used as the material for the housing.

However, because the plastic material is approximately vulnerable to heat, there may occur a problem in that the housing made of a plastic material is damaged by heat generated by the heat generating member in the heater during the process of operating the heater for raising a temperature. In order to prevent damage to the housing made of a plastic material, the fuse member needs to quickly cut off the supply of electric power before the temperature in the housing exceeds the predetermined temperature.

However, in the related art, thermal energy cannot be quickly transferred to the fuse member even though the internal temperature of the housing of the heater for raising a temperature is high. For this reason, there is a problem in that the housing made of a plastic material is highly likely to be damaged before the fuse member operates.

### SUMMARY

The present disclosure relates to a heater. Particular embodiments relate to a heater capable of being used to raise a temperature of a battery.

Embodiments of the present disclosure can quickly transfer thermal energy to a fuse member from the inside of a housing of a heater for raising a temperature, thereby preventing damage to the housing caused by an increase in temperature.

An embodiment of the present disclosure provides a heater including a housing member having an internal space in which a cooling fluid is stored, a heating member accommodated in the internal space and configured to generate heat, a partition wall member provided at one side of the heating member, extending in an upward/downward direction, and configured to seal the internal space, a fuse member provided at a side of the partition wall member opposite to a side facing the internal space and configured to cut off a supply of electric power to the heating member when a temperature thereof exceeds a predetermined temperature, and a heat transfer member having one side provided to be in contact with the partition wall member and the other side provided to be in contact with the fuse member, the heat transfer member being configured to transfer thermal energy to the fuse member from the partition wall member.

The fuse member may be spaced apart downward from an upper end of the heating member.

The fuse member may be provided to face a central region of the heating member in the upward/downward direction.

The fuse member may be provided to face an upper region of the heating member.

An upper end region of the heat transfer member may be provided to face an upper end region of the heating member.

An upper end region of the heat transfer member may be positioned above an upper end region of the heating member.

Thermal conductivity of the heat transfer member may be higher than thermal conductivity of the partition wall member.

A size of the heat transfer member may be smaller than a size of the partition wall member.

An overall region of the heat transfer member, which faces the partition wall member, may be provided to be in contact with the partition wall member.

A length of the heat transfer member in the upward/downward direction may be equal to or longer than a distance in the upward/downward direction between an upper end of the heating member and the fuse member.

A thickness of the heat transfer member may be smaller than a thickness of the partition wall member.

A level of the cooling fluid may be positioned below an upper end region of the heating member.

A level of the cooling fluid may be positioned above the fuse member.

The housing member may include polyphenylene sulfide (PPS) or may be made of PPS.

The partition wall member may include SUS or may be made of SUS.

According to embodiments of the present disclosure, it is possible to quickly transfer thermal energy to the fuse member from the inside of the housing of the heater for raising a temperature, thereby preventing damage to the housing caused by an increase in temperature.

### BRIEF DESCRIPTION OF THE DRAWINGS

FIG. 1 is a cross-sectional side view of a heater according to embodiments of the present disclosure.

FIG. 2 is a front view illustrating the heater illustrated in FIG. 1 when viewed from a right region.

### DETAILED DESCRIPTION OF ILLUSTRATIVE EMBODIMENTS

Hereinafter, a heater according to embodiments of the present disclosure will be described with reference to the drawings.

### Heater

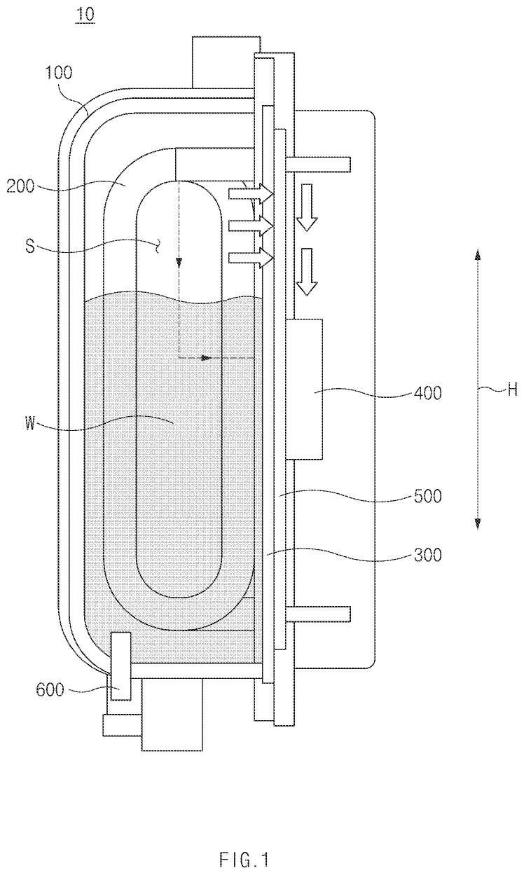

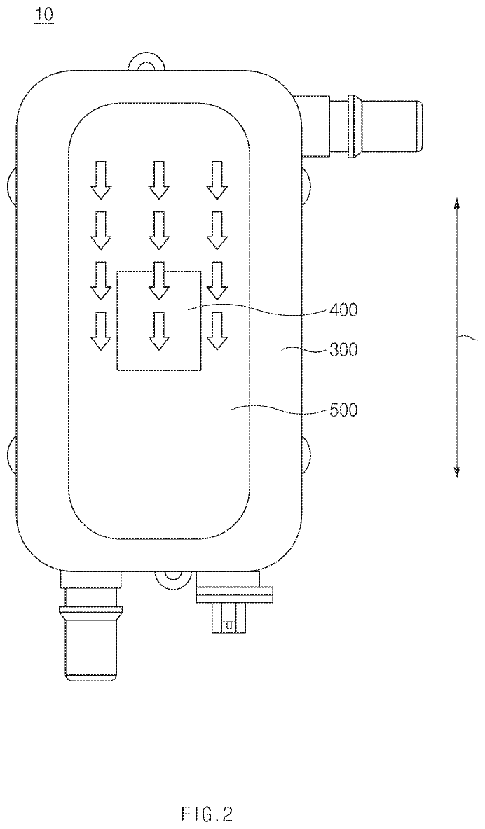

FIG. 1 is a cross-sectional side view of a heater according to embodiments of the present disclosure, and FIG. 2 is a front view illustrating the heater illustrated in FIG. 1 when viewed from a right region.

A heater 10 according to embodiments of the present disclosure may be configured to raise a temperature of a battery to allow the battery to exhibit normal performance. More specifically, the heater 10 may heat a cooling fluid and supply the heated cooling fluid to the battery, thereby heating the battery. For example, the battery may be mounted in a vehicle, and the heater 10 may also be mounted in the vehicle equipped with the battery.

With reference to the drawings, the heater 10 according to embodiments of the present disclosure may include a housing member 100 having an internal space S in which a cooling fluid W may be stored and a heating member 200 accommodated in the internal space S and configured to generate heat. Therefore, when the heating member 200 operates in a state in which the cooling fluid W is stored in the internal space S of the housing member 100, the cooling fluid W may be heated. For example, the heating member 200 may be an electric heater that receives electric power and converts electrical energy into thermal energy.

With reference to the drawings, the heater 10 according to embodiments of the present disclosure may further include a partition wall member 300 provided at one side of the heating member 200, extending in an upward/downward direction H, and configured to seal the internal space S from the outside. FIG. 1 illustrates that the internal space S is provided at a left side of the partition wall member 300.

In addition, the heater 10 according to embodiments of the present disclosure may further include a fuse member 400 disposed at a side of the partition wall member 300 opposite to a side facing the internal space S and configured to cut off a supply of electric power to the heating member 200 when a temperature thereof exceeds a predetermined temperature. That is, the fuse member 400 may be provided to face the internal space S and the heating member 200 with the partition wall member 300 interposed therebetween. More specifically, the heating member 200 may be electrically connected to an external electric power source (not illustrated) through a circuit part (not illustrated), and the fuse member 400 may be provided on the circuit part. Therefore, when the temperature of the fuse member 400 exceeds the predetermined temperature, the fuse member 400 may physically cut off the supply of electric power to be supplied to the heating member 200 through the circuit part. For example, the fuse member 400 may be a thermal fuse disclosed in the related art.

As described above, the fuse member 400 operates to cut off the supply of electric current when the temperature exceeds the predetermined temperature. As illustrated in FIG. 1, in case that a level of the cooling fluid W is higher than the fuse member 400 in the upward/downward direction H, the heat generated by the heating member 200 is absorbed by the cooling fluid W, and the heat cannot be properly transferred to the fuse member 400. This situation also occurs when the level of the cooling fluid W is relatively low, and an upper region of the heating member 200 is exposed to air, as illustrated in FIG. 1. However, when a part of the heating member 200 is exposed to air, the heat, which is generated in the region of the heating member 200 exposed to air, may be transferred directly to the housing member 100 without being absorbed by the cooling fluid W. This may cause damage to the housing member 100 and adversely affect the durability of the heater 10.

Embodiments of the present disclosure may additionally provide a configuration for solving the above-mentioned problem. That is, as illustrated in FIGS. 1 and 2, the heater 10 according to embodiments of the present disclosure may further include a heat transfer member 500 having one side provided to be in contact with the partition wall member 300. As the name implies, the heat transfer member 500 may be configured to transfer thermal energy to the fuse member 400 from the partition wall member 300. In this case, at least a part of the thermal energy absorbed by the partition wall member 300 may be heat generated from a portion of the heating member 200 that is exposed to air without being immersed in the cooling fluid W. Therefore, according to embodiments of the present disclosure, thermal energy, which is generated from the portion of the heating member 200 exposed to air, may sequentially pass through the partition wall member 300 and the heat transfer member 500 and be transferred to the fuse member 400. Therefore, the thermal energy, which is generated in the upper region of the heating member 200 that is easily exposed to air, may be quickly transferred to the fuse member 400 before the thermal energy reaches the housing member 100 and damages the housing member 100, thereby ensuring a quick operation of the fuse member 400.

Meanwhile, the transfer of thermal energy through the heat transfer member 500 may be implemented by thermal conduction. Therefore, in order to quickly transfer thermal energy to the fuse member 400, the thermal conductivity of the heat transfer member 500 may be higher than the thermal conductivity of the partition wall member 300. For example, the heat transfer member 500 may be made of a metallic material with high thermal conductivity. For example, the heat transfer member 500 may include aluminum or copper or may be made of aluminum or copper.

For example, as illustrated in FIG. 1, the fuse member 400 may be spaced apart downward from an upper end of the heating member 200. In this case, the thermal energy generated at the upper end of the heating member 200 is transferred to the partition wall member 300 first, and the thermal energy is transferred to the heat transfer member 500 from the partition wall member 300. Thereafter, the thermal energy may move downward along the heat transfer member 500 and then be transferred to the fuse member 400. The drawing illustrates an example in which the fuse member 400 is provided to face a central region of the heating member 200 in the upward/downward direction H with the partition wall member 300 interposed therebetween. However, unlike the drawing, the fuse member 400 may be provided to face the upper region of the heating member 200. In this case, the thermal energy generated at the upper end of the heating member 200 may be advantageously transferred to the fuse member 400 more quickly.

Meanwhile, as described above, the thermal energy generated in the upper region of the heating member 200 needs to be smoothly transferred to the heat transfer member 500 so that the fuse member 400 may quickly operate before the thermal energy generated by the heating member 200 damages the housing member 100.

In order to achieve this, the upper end of the heat transfer member 500 may be at least equal to or higher than the upper end of the heating member 200 in height in the upward/downward direction H. That is, according to embodiments of the present disclosure, an upper end region of the heat transfer member 500 may be provided to face an upper end region of the heating member 200, or the upper end region of the heat transfer member 500 may be provided above the upper end region of the heating member 200.

Meanwhile, because the heat transfer member 500 only needs to transfer the thermal energy, which is received from the partition wall member 300, to the fuse member 400 in order to sufficiently exhibit the function thereof, the heat transfer member 500 need not be excessively large in size. Therefore, according to embodiments of the present disclosure, the size of the heat transfer member 500 may be smaller than the size of the partition wall member 300. However, even in this case, the thermal energy, which is generated in the upper region of the heating member 200, needs to be smoothly transferred to the fuse member 400 through the heat transfer member 500. Therefore, a length of the heat transfer member 500 in the upward/downward direction H may be equal to or longer than a distance in the upward/downward direction H between the upper end of the heating member 200 and the fuse member 400. More particularly, a height of the upper end of the heat transfer member 500 in the upward/downward direction H may be equal to or higher than a height of the upper end of the heating member 200 in the upward/downward direction H, and a height of a lower end of the heat transfer member 500 in the upward/downward direction H may be equal to or lower than a height of the fuse member 400 in the upward/downward direction H. In addition, an overall region of the heat transfer member 500, which faces the partition wall member 300, may be provided to be in contact with the partition wall member 300 so that the thermal energy may be smoothly transferred to the heat transfer member 500 from the partition wall member 300.

Meanwhile, in a more exemplary example, a thickness of the heat transfer member 500 may be relatively smaller than a thickness of the partition wall member 300. In this case, a temperature gradient (thermal gradient) in a thickness direction of the heat transfer member 500 increases, such that the thermal energy may be more quickly transferred to the fuse member 400 through the heat transfer member 500.

Meanwhile, in the heater 10 according to embodiments of the present disclosure, the housing member 100 may be made of a plastic material. In comparison with a metallic material, the plastic material is advantageously inexpensive and light in weight, but the plastic material is relatively vulnerable to heat. Therefore, according to embodiments of the present disclosure, the heat transfer member 500 is provided in the heater 10, such that even in a case in which the housing member 100 is made of a plastic material, the fuse member 400 may quickly operate before the housing member 100 is damaged by heat. For example, the housing member 100 may include polyphenylene sulfide (PPS) or may be made of PPS. Meanwhile, the partition wall member 300 may be made of a metallic material or may include a metallic material. For example, the partition wall member 300 may include SUS or may be made of SUS.

Meanwhile, a relative positional relationship between the level of the cooling fluid W, the heating member 200, and the fuse member 400 when the heater 10 operates in the state in which the cooling fluid W is accommodated in the heater 10 according to embodiments of the present disclosure will be described below. Meanwhile, it will be appreciated that the following description is based on the premise that the cooling fluid W is also one component of the heater 10 according to embodiments of the present disclosure.

With reference to the drawings, the level of the cooling fluid W may be positioned below the upper end region of the heating member 200. This may show that a partial region of the heating member 200 is exposed to air. In addition, the level of the cooling fluid W may be positioned above the fuse member 400. In this case, the thermal energy may be smoothly transferred to the fuse member 400 through the partition wall member 300 and the heat transfer member 500 via the section indicated by the solid arrows illustrated in FIG. 1, even in the case in which the thermal energy, which is generated in the upper region of the heating member 200 exposed to air, cannot be properly transferred to the fuse member 400 via the section indicated by the dotted arrows illustrated in FIG. 1 because of the cooling fluid W.

Meanwhile, the heater 10 according to embodiments of the present disclosure may further include a temperature sensor 600 configured to measure a temperature of the cooling fluid W. As illustrated in FIG. 1, the temperature sensor 600 may be provided in a lower region of the housing member 100 to smoothly measure the temperature of the cooling fluid W even in a case in which the level of the cooling fluid Wis low.

Embodiments of the present disclosure have been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A heater comprising:
a housing member having an internal space in which a cooling fluid is stored;
a heating member accommodated in the internal space and configured to generate heat;
a partition wall member disposed at a first side of the heating member, extending in an upward/downward direction, and configured to seal the internal space;
a fuse member disposed at a side of the partition wall member opposite to a side facing the internal space and configured to cut off a supply of electric power to the heating member in a case in which a temperature of the fuse member exceeds a predetermined temperature; and
a heat transfer member having a first side disposed to be in contact with the partition wall member and a second side disposed to be in contact with the fuse member, the heat transfer member being configured to transfer thermal energy to the fuse member from the partition wall member.

2. The heater of claim 1, wherein the fuse member is spaced apart downward from an upper end of the heating member.

3. The heater of claim 1, wherein the fuse member faces a central region of the heating member in the upward/downward direction.

4. The heater of claim 1, wherein the fuse member faces an upper region of the heating member.

5. The heater of claim 1, wherein an upper end region of the heat transfer member faces an upper end region of the heating member.

6. The heater of claim 1, wherein an upper end region of the heat transfer member is positioned above an upper end region of the heating member.

7. The heater of claim 1, wherein thermal conductivity of the heat transfer member is higher than thermal conductivity of the partition wall member.

8. The heater of claim 1, wherein a size of the heat transfer member is smaller than a size of the partition wall member.

9. The heater of claim 1, wherein a region of the heat transfer member facing the partition wall member is in contact with the partition wall member.

10. The heater of claim 1, wherein a length of the heat transfer member in the upward/downward direction is equal to or longer than a distance in the upward/downward direction between an upper end of the heating member and the fuse member.

11. The heater of claim 1, wherein a thickness of the heat transfer member is smaller than a thickness of the partition wall member.

12. The heater of claim 1, wherein an upper level of the cooling fluid is below an upper end region of the heating member.

13. The heater of claim 1, wherein an upper level of the cooling fluid is positioned above the fuse member.

14. The heater of claim 1, wherein the housing member comprises polyphenylene sulfide (PPS).

15. The heater of claim 1, wherein the partition wall member comprises SUS.
